(19) United States
(12) Patent Application Publication
(10) Pub. No.: US 2007/0218790 A1
(43) Pub. Date: Sep. 20, 2007

(54) Composite insulation

(75) Inventor: Aaron J. Schradin, Holland, MI (US)

Correspondence Address: BAKER & DANIELS LLP, 205 W. JEFFERSON BOULEVARD, SUITE 250, SOUTH BEND, IN, 46601, US

(73) Assignee: AM General LLC

(21) Appl. No.: 11/377,741

(22) Filed: Mar. 16, 2006

(51) Int. Cl. B32B 27/12; B32B 27/04

(52) U.S. Cl. 442/38; 442/45

(57) ABSTRACT

Articles, methods and vehicles are provided in connection with composite insulation. An article embodiment includes a moisture-resistant layer attached to a first surface of a sound-absorbing layer. The article embodiment also includes a heat-reflective layer attached to a second surface of the sound-absorbing layer.

### BACKGROUND

In the field of insulation, various materials can be used to provide insulation in different applications. One such application is providing insulation for vehicles. Many vehicles generate heat and/or noise in their operation and/or encounter heat and/or noise in their outside environment. As a result, it can be useful to insulate a vehicle's passenger area from unsafe or uncomfortable levels of heat and/or noise. For example, vehicle insulation can insulate a vehicle's passenger area from the heat and the noise of the vehicle's exhaust system. In some instances, it can also be useful to insulate other parts of a vehicle from heat and/or noise. As an example, vehicle insulation can insulate a vehicle's electronics from the heat of the vehicle's engine compartment. Further, it can be useful for vehicle insulation to provide uniform insulation from such heat and/or noise. Throughout this document, references to insulating include the concept of partially insulating, and references to insulation include materials and articles that partially insulate.

It can be useful to provide vehicle insulation that can be installed in a vehicle without being damaged. It can also be useful to provide vehicle insulation that performs well when exposed to a vehicle's outside environment. Vehicle insulation that is moisture-resistant can resist absorbing moisture when exposed to contact with moisture in the outside environment. Also, vehicle insulation that is impact-resistant can resist being damaged when exposed to impacts from flying debris in the outside environment. Further, vehicle insulation that resists foreign body passthru (FBP) can resist penetration by foreign bodies, such as projectiles.

Various materials are currently used to provide insulation for vehicles, however these materials can experience difficulties in this application. A current type of vehicle insulation includes a layer of dampening material on a fiberglass structure, with painted edges and holes. The fiberglass structure in this type of vehicle insulation can be prone to fracturing as it is installed in vehicles. When this type of vehicle insulation is exposed to moisture, the dampening material can absorb the moisture, which can increase a vehicle's weight and thus decrease the vehicle's load carrying performance. Also, when this current type of insulation is exposed to flying debris or foreign bodies, the fiberglass structure can crack, requiring repair or replacement. Further, for vehicle insulation that includes dampening material on a fiberglass structure, the thickness of the dampening material can vary across the fiberglass structure, resulting in varying degrees of insulation from noise.

### BRIEF DESCRIPTION OF THE DRAWINGS

FIG. 1 illustrates a vehicle, which includes embodiments of composite insulation articles according to the present disclosure.

FIG. 2A illustrates a side view of cross-sections of three layers for an embodiment of a composite insulation article according to the present disclosure.

FIG. 2B illustrates a side view of a cross-section of an embodiment of a three-layer composite insulation article according to the present disclosure.

FIG. 3A illustrates a top view of another embodiment of a three-layer composite insulation article according to the present disclosure.

FIG. 3B illustrates a section view of another embodiment of a three-layer composite insulation article according to the present disclosure.

FIG. 3C illustrates a bottom view of another embodiment of a three-layer composite insulation article according to the present disclosure.

FIG. 4A illustrates a side view of cross-sections of five layers for an embodiment of a composite insulation article according to the present disclosure.

FIG. 4B illustrates a side view of a cross-section of an embodiment of a five-layer composite insulation article according to the present disclosure.

FIG. 5A illustrates a top view of another embodiment of a five-layer composite insulation article according to the present disclosure.

FIG. 5B illustrates a section view of another embodiment of a five-layer composite insulation article according to the present disclosure.

FIG. 5C illustrates a bottom view of another embodiment of a five-layer composite insulation article according to the present disclosure.

### DETAILED DESCRIPTION

The present disclosure includes embodiments of articles, methods, and vehicles in connection with composite insulation. For example, an embodiment of a composite insulation article includes a moisture-resistant layer attached to a first surface of a sound-absorbing layer. This embodiment of the composite insulation article also includes a heat-reflective layer attached to a second surface of the sound-absorbing layer.

Embodiments of composite insulation of the present disclosure can be used to provide substantially uniform insulation from heat and/or noise. For example, such composite insulation can be used to provide insulation from heat and/or noise for vehicles. Embodiments of the present disclosure can exhibit sufficient toughness to be installed in vehicles without being damaged. When embodiments of the present disclosure are used as vehicle insulation, the composite insulation can perform well when exposed to a vehicle's outside environment. As examples, embodiments of this composite insulation can be moisture-resistant and impact-resistant, as well as resistant to FBP. Embodiments of the present disclosure can also be used in various additional applications to provide insulation from heat and/or noise, such as providing insulation for shelters, dwellings, or other structures.

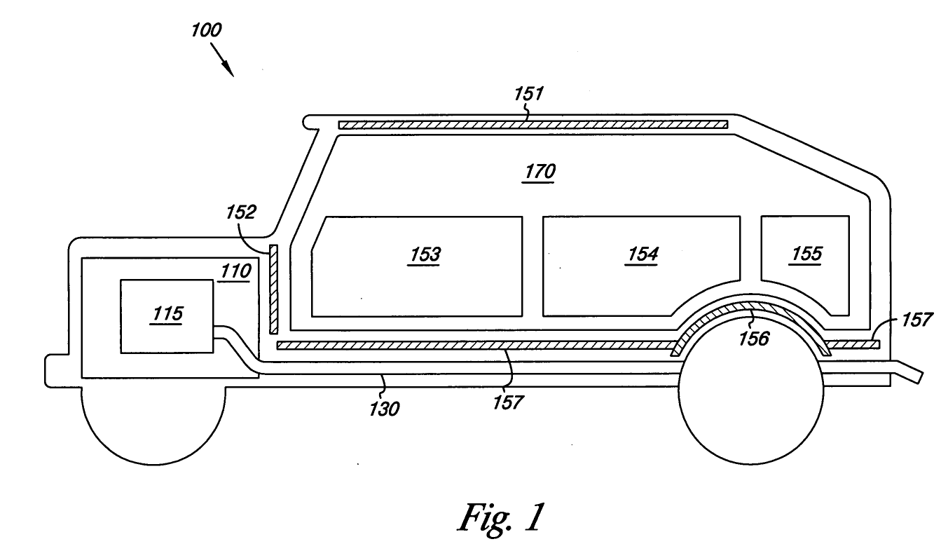

FIG. 1 illustrates a vehicle 100, which includes embodiments of composite insulation articles according to the present disclosure. The vehicle 100 includes an engine compartment 110, an engine 115, an exhaust system 130, a first composite insulation article 151, a second composite insulation article 152, a third composite insulation article 153, a fourth composite insulation article 154, a fifth composite insulation article 155, a sixth composite insulation article 156, a seventh composite insulation article 157, and a passenger compartment 170. FIG. 1 is intended to illustrate embodiments of the present disclosure used as vehicle insulation, and is not intended to illustrate all details of the vehicle 100.

In the embodiment of FIG. 1, the vehicle 100 is illustrated as a truck; however the composite insulation of the present disclosure can be used with various types of vehicles, such as cars, vans, buses, and other land vehicles for conveying human passengers. Further, the composite insulation of the present disclosure can be used with other types of vehicles to provide insulation from heat and/or noise.

The engine compartment 110 is in the front portion of the vehicle 100, however an engine compartment can be provided in various other locations in a vehicle, such as the middle or the back portion of the vehicle. The engine compartment 110 contains the engine 115.

The engine 115 generates heat and noise as the vehicle 110 operates. In the embodiment of FIG. 1, the engine 115 represents an internal combustion engine, however the engine 115 can be any type of mechanical, electrical, and/or chemical machine and/or process that generates heat and/or noise as the vehicle 100 operates. The engine 115 is connected to the exhaust system 130.

The exhaust system 130 conveys exhaust and noise from the engine 115 to an outlet at a back of the vehicle 100. For simplicity, the exhaust system 130 is illustrated as a single pipe extending beneath the passenger compartment 170 along an underside of the vehicle 100. However, an exhaust system of a vehicle can include various components and can be configured in various arrangements. The exhaust system 130 gives off heat and noise as it conveys the exhaust and the noise from the engine 115.

The passenger compartment 170 is a space in the vehicle 100 in which human passengers can be conveyed by the vehicle 100. In the embodiment of FIG. 1, the passenger compartment 170 is illustrated as an enclosed space, however, in various embodiments, a passenger compartment can be a partially open space or a fully open space. The passenger compartment 170 can be a space of various sizes and shapes.

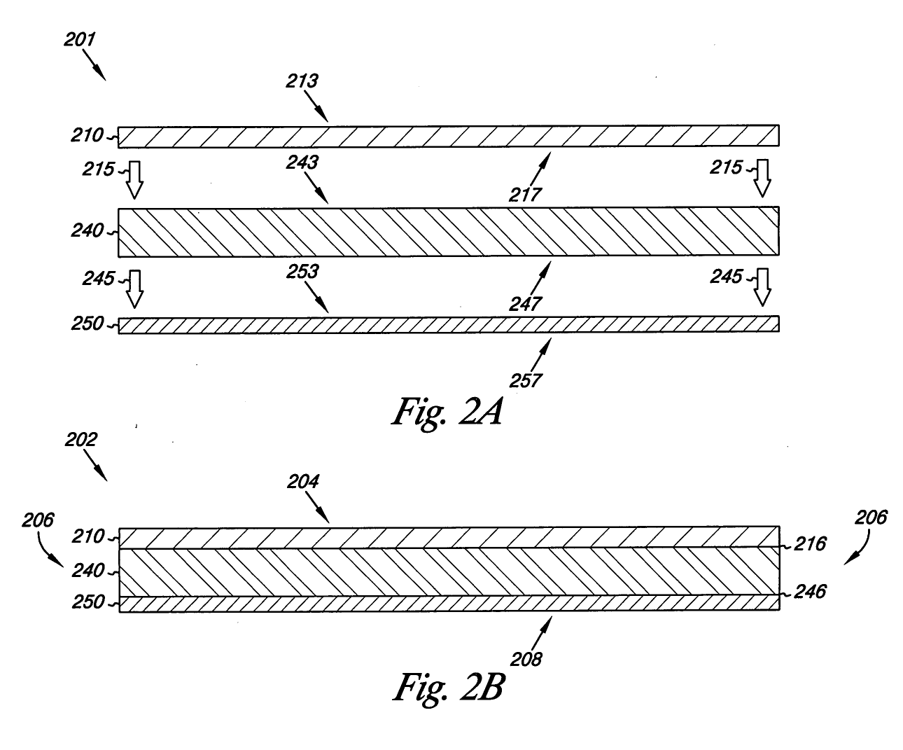

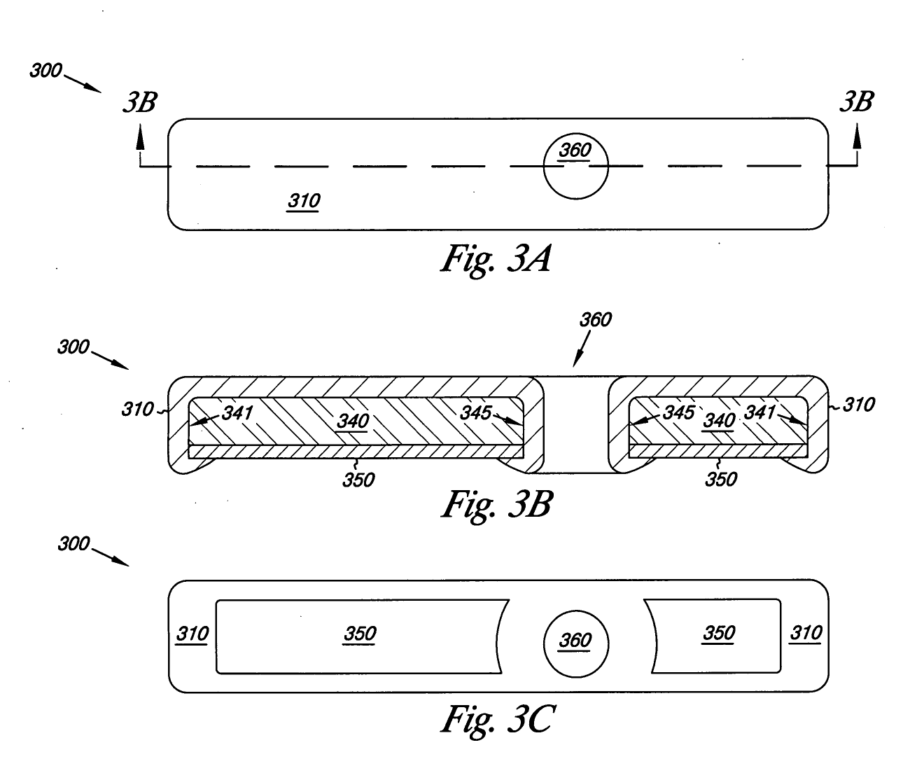

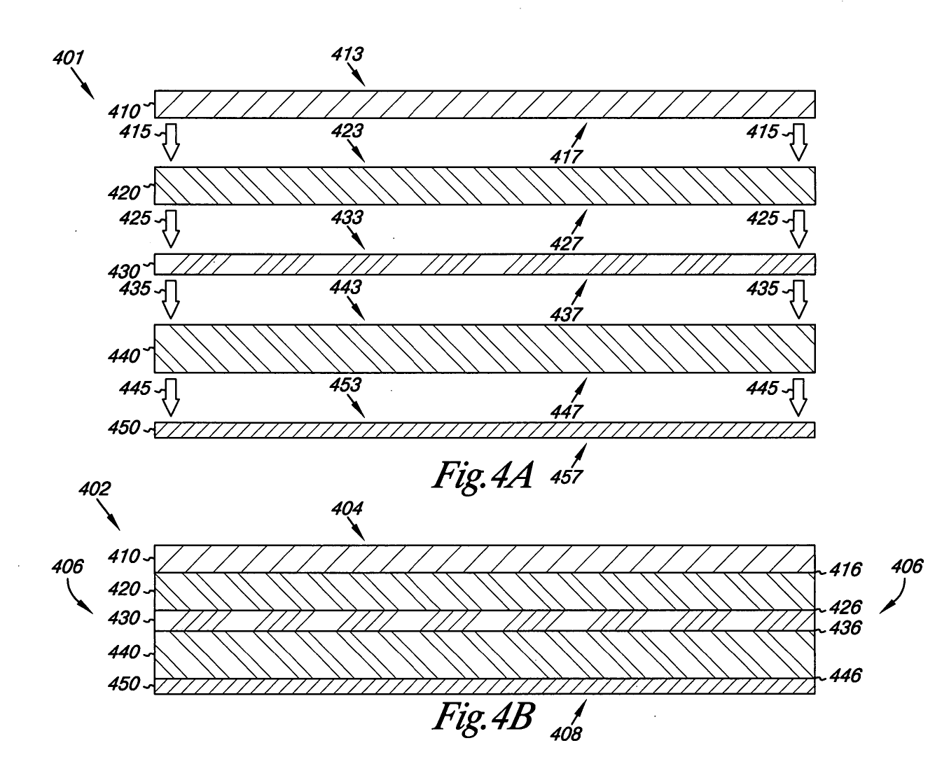

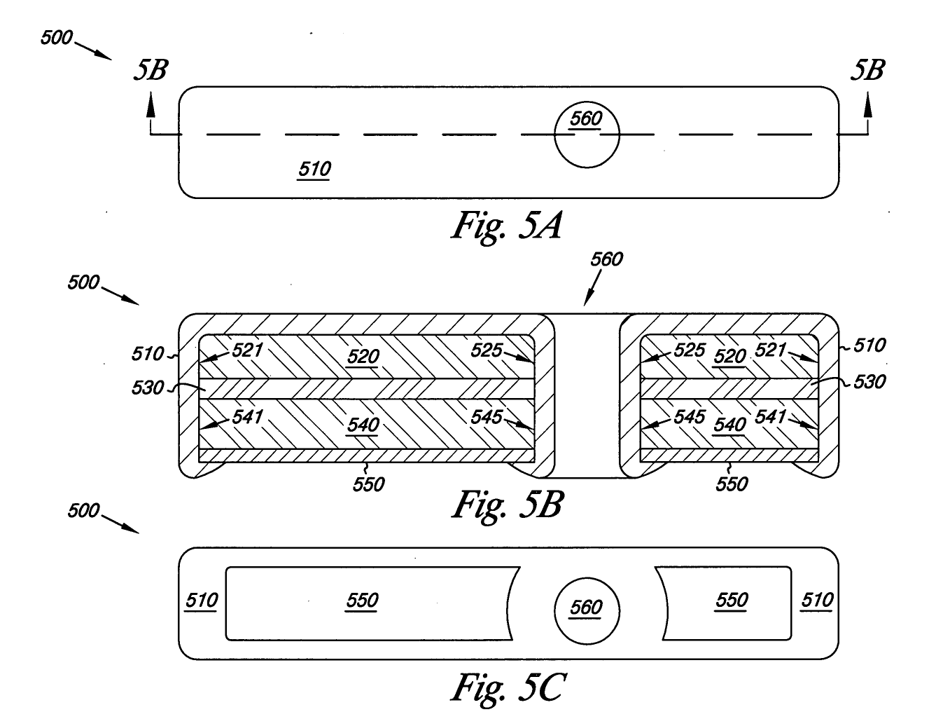

The composite insulation articles 151-157 are articles of composite insulation according to embodiments of the present disclosure. In various embodiments, these composite insulation articles can be the composite insulation article 202 of the embodiment of FIG. 2, the composite insulation article 300 of the embodiment of FIG. 3, the composite insulation article 402 of the embodiment of FIG. 4, or the composite insulation article 500 of the embodiment of FIG. 5. Each of the composite insulation articles 151-157 can be used apart from the other composite insulation articles. In various embodiments, some or all of the composite insulation articles 151-157 can be used along with other forms of insulation.

The first composite insulation article 151 is positioned above the passenger compartment 170 in a roof of the vehicle 100. The first composite insulation article 151 can be positioned so that a heat-reflective layer of the first composite insulation article 151 faces the top of the vehicle 100. The first composite insulation article 151 can be used to insulate the passenger compartment 170 from the heat of sunlight on the roof of the vehicle 100.

The second composite insulation article 152 is positioned between the engine compartment 110 and the passenger compartment 170. The second composite insulation article 152 can be positioned so that a heat-reflective layer of the second composite insulation article 152 faces the engine compartment 110. The second composite insulation article 152 can be used to insulate the passenger compartment 170 from the heat and noise generated by the engine 115 in the engine compartment 110.

The third composite insulation article 153, the fourth composite insulation article 154, and the fifth composite insulation article 155 are positioned along a side of the passenger compartment 170. The composite insulation articles 153, 154, and 155 can be positioned so that a heat-reflective layer of each composite insulation article faces an outside of the vehicle 100. For example, the composite insulation articles 153, 154, and 155 can be incorporated into one or more doors or body panels of the vehicle 100. The third, fourth, and fifth composite insulation articles 153, 154, and 155 can be used to insulate the passenger compartment 170 from the heat of sunlight on the side of the vehicle 100, as well as to insulate the passenger compartment from noise in the external environment of the vehicle 100.

The sixth composite insulation article 156 is positioned between a wheel of the vehicle 100 and the passenger compartment 170. The sixth composite insulation article 156 can be positioned so that a heat-reflective layer of the sixth composite insulation article 156 faces the wheel. The sixth composite insulation article 156 can be used to insulate the passenger compartment 170 from the noise of the wheel on a road, as well as to insulate the passenger compartment from heat in the external environment of the vehicle 100.

The seventh composite insulation article 157 is positioned between the exhaust system 130 and the passenger compartment 170. The seventh composite insulation article 157 can be positioned so that a heat-reflective layer of the seventh composite insulation article 157 faces the exhaust system 130. The seventh composite insulation article 157 can be used to insulate the passenger compartment 170 from the heat and noise given off by the exhaust system 130.

The composite insulation articles of the present disclosure can be used to provide various embodiments of vehicle insulation. One or more composite insulation articles of various sizes and shapes can be used to provide vehicle insulation from heat and/or noise. Such composite insulation articles can be positioned in various ways between sources of heat and/or noise and parts of a vehicle to be insulated from heat and/or noise. The composite insulation articles of the present disclosure can also be used to provide insulation from heat and/or noise in a vehicle's outside environment. The composite insulation articles of the present disclosure can be attached to a vehicle in various ways, such as by using fasteners, adhesives, and/or structural capture elements.

FIGS. 2A-5C include embodiments of composite insulation articles of the present disclosure. These figures illustrate relationships between layers in the composite insulation articles. However these figures are not intended to illustrate the actual or relative thicknesses of the layers. Further, FIGS. 2A-5C are not intended to illustrate all details of how various layers can be joined together, according to the present disclosure.

FIGS. 2A-5C also include various embodiments of methods for manufacturing composite insulation articles of the present disclosure. Unless explicitly stated, the performance of these method embodiments and/or their elements are not constrained to a particular order or sequence. Additionally, some of the method embodiments and/or their elements can be performed at the same time.

FIG. 2A illustrates a side view of cross-sections of three layers 201 for an embodiment of a composite insulation article according to the present disclosure. The three layers 201 include a moisture-resistant layer 210, a sound-absorbing layer 240, and a heat-reflective layer 250. The moisture-resistant layer 210 includes a first surface 213 and a second surface 217. The sound-absorbing layer 240 also includes a first surface 243 and a second surface 247. Similarly, the heat-reflective layer 250 includes a first surface 253 and a second surface 257.

The moisture-resistant layer 210 can resist absorbing moisture when exposed to contact with moisture, including moisture that a vehicle may encounter in its environment, such as water, engine oil, engine coolant, etc. In various embodiments of the present disclosure, the moisture-resistant layer 210 can include various polymers including thermoplastics and thermosets. The thermoplastics can include polyethylene, polypropylene, polystyrene, polyvinylchloride, polytetrafluorethylene, ABS, polyamide, acrylic, acetal, ceullulosic, polycarbonate, some forms of polyester, and other thermoplastics. The thermosets can include phenolic, urea-melamine, other forms of polyester, epoxy, urethane, silicone, and other thermosets.

The moisture-resistant layer 210 can include polymers with various cross-linking. Various polymers in the moisture-resistant layer 210 can be cross-linked by applying heat and/or pressure to the polymers and/or by introducing one or more cross-linking agents to the polymers. As examples, sulfur can be used as a cross-linking agent in vulcanization and oxygen can be used as a cross-linking agent in oxidation. In the moisture-resistant layer 210, a polymer can be cross-linked to varying degrees to obtain a particular modulus of elasticity.

In an embodiment of the present disclosure, the moisture-resistant layer 210 can include a monolithic elastomeric material. For example, the monolithic elastomeric material can be an elastomer such as natural rubber, Buna S, isoprene, nitrile, neoprene, silicone, urethane, or other elastomers. In one embodiment, the moisture-resistant layer 210 can include Line-X® which is a monolithic elastomeric material commercially available from Line-X Corp. of Santa Ana, Calif.

The sound-absorbing layer 240 can absorb sound to provide insulation from noise. In various embodiments, the sound absorbing layer 240 may also provide insulation from heat. The sound-absorbing layer 240 can include various materials such as polyolefins, polyethylene, cotton shoddy, nylon, rayon, acrylic, natural fibers, and polyethylene terephthalate (PET).

When the sound-absorbing layer 240 includes PET, the PET can be provided as a mat of fibrous material, in various densities and thicknesses. Various densities of PET can absorb different frequencies of sound. For example, a composite insulation using PET with a density of 42 ounces per square foot has been tested for use as vehicle insulation with favorable results. In general, less dense PET can absorb lower frequencies of sound while more dense PET can absorb higher frequencies of sound. Various thicknesses of PET can absorb different levels of sound, with thicker PET generally able to absorb louder noise. As an example, composite insulation using PET with thicknesses of 3-12 millimeters has been tested for use as vehicle insulation with favorable results. When used in the sound-absorbing layer 240, the density and thickness of PET can be chosen for particular insulation applications, based on the frequencies and the levels of the noise to be insulated. In some embodiments, the density and thickness of PET can also be changed by compressing the sound-absorbing layer 240, to obtain more dense and less thick PET.

The heat reflective layer 250 can reflect radiant heat away from its surface, to prevent the heat from being absorbed and conducted. The heat reflective layer 250 can include one or more reflective metals, such as aluminum, as well as reflective metal alloys or reflective metallic materials. In embodiments of the present disclosure, the heat reflective layer 250 may comprise any heat reflective material. The heat-reflective layer 250 can be polished and/or chemically treated, in some embodiments, to enhance or preserve its reflectivity.

The heat reflective layer 250 can be various thicknesses, from foil thickness to thickness on the order of several millimeters, with thicker heat-reflective layers generally providing greater strength and impact-resistance. The thickness of the heat-reflective layer 250 can be chosen for particular insulation applications, based on strength requirements and expected impacts. The heat-reflective layer 250 can also include fiber reinforcements, in order to provide increased strength. In various embodiments, when the heat-reflective layer 250 is a solid metallic layer, the heat-reflective layer 250 can also be moisture-resistant.

The three layers 201 can be combined to form the three-layer composite insulation article 202 of the embodiment of FIG. 2B. The moisture-resistant layer 210 can be attached 215 to the sound-absorbing layer 240. For example, the second surface 217 of the moisture-resistant layer 210 can be attached to the first surface 243 of the sound-absorbing layer 240 in various ways, as described below. In various embodiments of the present disclosure, the moisture-resistant layer 210 can be attached so that it covers substantially all of the first surface 243 of the sound-absorbing layer 240. As a result, the moisture-resistant layer 210 can provide moisture resistance to the first surface 243 of the sound-absorbing layer 240.

In an embodiment of the present disclosure, the moisture-resistant layer 210 can be attached 215 to the sound-absorbing layer 240 by applying the moisture-resistant layer 210 in liquid form as a coating and curing the coating until it solidifies. This coating can be applied by spraying or brushing the moisture-resistant layer 210 onto the sound-absorbing layer 240 or by dipping the sound-absorbing layer 240. Such coatings can be cured in various ways, such as air-drying and/or heating. In some embodiments, one or more additional coatings can be applied, to obtain a particular thickness for the moisture-resistant layer 210.

The moisture-resistant layer 210 can, in some embodiments, be attached 215 to the sound-absorbing layer 240 by one or more adhesives including thermoplastics, thermosets, elastomers, and alloy adhesives. The thermoplastics can include cellulose acetate, polyvinyl acetate, polyvinyl acetal, polyamide, and acrylic. The thermosets can include cyanoacrylate, urea formaldehyde, melamine formaldehyde, epoxy, and polyimide. The elastomers can include natural rubber, butyl, nitrile, polyurethane, polysulfide, silicone, and neoprene. The alloy adhesives can include epoxy-phenolic, epoxy-nylon, neoprene phenolic, and vinyl-phenolic.

The moisture-resistant layer 210 can be attached 215 to the sound-absorbing layer 240, in various embodiments, by fusing. Some materials can be directly fused to other materials. For example, PET can be fused to another material by placing the PET and the other material in contact with each other, heating the PET (e.g. by flaming) to a temperature above its glass transition point, and then cooling the PET to a temperature below its glass transition point. In this example, the PET can fuse to the other material, creating an attachment. Thus, when the sound-absorbing layer 240 is PET, the sound-absorbing layer 240 can be fused to the moisture-resistant layer 210.

The sound-absorbing layer 240 can also be attached 245 to the heat-reflective layer 250. For example, the second surface 247 of the sound-absorbing layer 240 can be attached to the first surface 253 of the heat-reflective layer 240 in various ways. The sound-absorbing layer 240 can also be attached 245 to the heat-reflective layer 250 by using one or more adhesives, as described above. When the sound-absorbing layer 240 is PET, the sound-absorbing layer 240 can be fused to the heat-reflective layer 250, also as described above. In various embodiments of the present disclosure, the sound-absorbing layer 240 can be attached so that the heat-reflective layer 250 covers substantially all of the second surface 247 of the sound-absorbing layer 240. As a result, the heat-reflective layer 250 can reflect radiant heat away from the sound-absorbing layer 240. In embodiments in which the heat-reflective layer 250 is also moisture-resistant, the heat-reflective layer 250 can also provide moisture resistance to the second surface 247 of the sound-absorbing layer 240.

FIG. 2B illustrates a side view of a cross-section of an embodiment of a three-layer composite insulation article 202 according to the present disclosure. The three-layer composite insulation article 202 can be formed from the three layers 201 as described in connection with FIG. 2A. The three-layer composite insulation article 202 includes the moisture-resistant layer 210, the sound-absorbing layer 240, and the heat-reflective layer 250. The moisture-resistant layer 210 is attached to the sound-absorbing layer 240 at a first joint 216, and the sound-absorbing layer 240 is attached to the heat-reflective layer 250 at a second joint 246.

The three-layer composite insulation article 202 also includes a first outside 204, edges 206, and a second outside 208. The first outside 204 includes the moisture-resistant layer 210, which can provide moisture-resistance for the three-layer composite insulation article 202. The sound-absorbing layer 240 is inside the three-layer composite insulation article 202. The second outside 208 includes the heat-reflective layer 250, which can reflect radiant heat away from the three-layer composite insulation article 202. The thickness of the sound-absorbing layer 240 can be substantially uniform across the three-layer composite insulation article 202, resulting in uniform insulation from noise. In various embodiments of the present disclosure, the three-layer composite insulation article 202 can be substantially rigid. The three-layer composite insulation article 202 can be used to form the three-layer composite insulation article 300 of the embodiment of FIG. 3A.

FIG. 3A illustrates a top view of another embodiment of a three-layer composite insulation article 300 according to the present disclosure. FIG. 3A illustrates a moisture-resistant layer 310, a through-hole 360, and an orientation of the section view of FIG. 3B.

FIG. 3B illustrates a section view of the three-layer composite insulation article 300 according to embodiments of the present disclosure. The three-layer composite insulation article 300 can be formed from the three-layer composite insulation article 202 of the embodiment of FIG. 2B. The three-layer composite insulation article 300 includes a moisture-resistant layer 310, which can be the moisture-resistant layer 210 of the embodiment of FIG. 2B, a sound-absorbing layer 340, which can be the sound-absorbing layer 240 of the embodiment of FIG. 2B, and a heat-reflective layer 350, which can be heat-reflective layer 250 of the embodiment of FIG. 2B. The sound-absorbing layer 340 includes edges 341, as well as edges 345 around the through-hole 360.

The moisture-resistant layer 310 is attached to the sound-absorbing layer 340. The moisture-resistant layer 310 can be attached to the sound-absorbing layer 340 in various ways, as described in connection with the embodiment of FIG. 2A. The moisture-resistant layer 310 can cover substantially all of a first surface of the sound-absorbing layer 340, substantially all of the edges 341 of the sound-absorbing layer 340, as well as substantially all of the edges 345 of the sound-absorbing layer 340. As a result, the moisture-resistant layer 310 can provide moisture-resistance for the first surface, the edges 341, and the edges 345 of the sound-absorbing layer 340.

The sound-absorbing layer 340 is also attached to the heat-reflective layer 350. The sound-absorbing layer 340 can be attached to the heat-reflective layer 350 in various ways, as described in connection with the embodiment of FIG. 2A. The heat-reflective layer 350 can cover substantially all of a second surface of the sound-absorbing layer 340. The heat-reflective layer 310 can reflect radiant heat away from the sound-absorbing layer 340. The moisture-resistant layer 310 and the heat-reflective layer 350 can substantially encapsulate the sound-absorbing layer 340. In an embodiment in which the heat-reflective layer 350 is also moisture-resistant, the moisture-resistant layer 310 and the heat-reflective layer 350 can provide moisture resistance to substantially all sides of the sound-absorbing layer 240.

In an alternate embodiment of the present disclosure, the sound absorbing layer 340 can be mechanically retained by its encapsulation between the moisture-resistant layer 310 and the heat-reflective layer 350, without attaching the sound absorbing layer 340 to the moisture-resistant layer 310 and/or the heat-reflective layer 350.

The three-layer composite insulation article 300 can be formed from the three-layer composite insulation article 202 of the embodiment of FIG. 2B, in various ways. For example, the three-layer composite insulation article 202 can be cut to the size and shape of the three-layer composite insulation article 300, using one or more of various cutting tools, such as a milling tools, drilling tools, cutting dies, water-jet cutters, etc. In this example, the through-hole 360 can be drilled through the three-layer composite insulation article 202.

In an embodiment of the present disclosure, the three-layer composite insulation article 300 can be formed by attaching the moisture-resistant layer 310 as a final step. In this embodiment, the sound-absorbing layer 340 can be attached to the heat-reflective layer 350, the two-layers can then be sized and shaped, and finally the moisture-resistant layer 310 can be attached to the sound-absorbing layer 340, as described in connection with the embodiment of FIG. 2A.

FIG. 3C illustrates a bottom view of the three-layer composite insulation article 300 according to embodiments of the present disclosure, including the moisture-resistant layer 310, the heat-reflective layer 350 and the through-hole 360.

FIG. 4A illustrates a side view of cross-sections of five layers 401 for an embodiment of a composite insulation article according to the present disclosure. The five layers 401 include a moisture-resistant layer 410, a first sound-absorbing layer 420, a fiber-mesh layer 430, a second sound-absorbing layer 440, and a heat-reflective layer 450.

Each of the five layers 401 includes a first surface and a second surface. The moisture-resistant layer 410 includes a first surface 413 and a second surface 417. The first sound-absorbing layer 420 also includes a first surface 423 and a second surface 427. The fiber-mesh layer 430 includes a first surface 433 and a second surface 437. The second sound-absorbing layer 440 also includes a first surface 443 and a second surface 447. Similarly, the heat-reflective layer 450 includes a first surface 453 and a second surface 457.

The moisture-resistant layer 410 can resist absorbing moisture when exposed to contact with moisture. In various embodiments of the present disclosure, the moisture-resistant layer 410 can be the moisture-resistant layer 210 of the embodiment of FIG. 2A.

The first sound-absorbing layer 420 and the second sound-absorbing layer 440 can absorb sound to provide insulation from noise. In various embodiments, these sound absorbing layers may also provide insulation from heat. The first sound-absorbing layer 420 and the second sound-absorbing layer 440 can each be the sound-absorbing layer 240 of the embodiment of FIG. 2A.

The fiber-mesh layer 430 can be a rigid layer, providing increased strength and rigidity to the five-layer composite insulation article 402 of the embodiment of FIG. 4B. In various embodiments, the fiber-mesh layer 430 can include high-tensile fibers, such as those found in carbon fiber material. In one embodiment, the fiber-mesh layer 430 can include Hardwire® which is a carbon fiber material commercially available from Hardwire, LLC of Pocomoke City, Md.

The heat-reflective layer 450 can reflect radiant heat away from its surface, to prevent the heat from being absorbed and conducted. In various embodiments of the present disclosure, the heat-reflective layer 450 can be the heat-reflective layer 250 of the embodiment of FIG. 2A.

The five layers 401 can be combined to form the five-layer composite insulation article 402 of the embodiment of FIG. 4B. The moisture-resistant layer 410 can be attached 415 to the first sound-absorbing layer 420, as described in connection with the attachment 215 of the embodiment of FIG. 2A. The second surface 427 of the sound-absorbing layer 420 can be attached 425 to the first surface 433 of the fiber-mesh layer 430, by using one or more adhesives or by fusing, as described in connection with the embodiment of FIG. 2A. Similarly, the second surface 437 of fiber-mesh layer 430 can be attached 435 to the first surface 443 of the second sound-absorbing layer 440, by using one or more adhesives or by fusing, as described in connection with the embodiment of FIG. 2A. The second sound-absorbing layer 440 can be attached 445 to the heat-reflective layer 450, as described in connection with the attachment 245 of the embodiment of FIG. 2A.

FIG. 4B illustrates a side view of a cross-section of an embodiment of a five-layer composite insulation article 402 according to the present disclosure. The five-layer composite insulation article 402 can be formed from the five layers 401 as described in connection with FIG. 4A. The five-layer composite insulation article 402 includes the moisture-resistant layer 410, the first sound-absorbing layer 420, the fiber-mesh layer 430, the second sound-absorbing layer 440, and the heat-reflective layer 450.

The moisture-resistant layer 410 is attached to the first sound-absorbing layer 420 at a first joint 416, the first sound-absorbing layer 420 is attached to the fiber-mesh layer 430 at a second joint 426, the fiber-mesh layer 430 is attached to the second sound-absorbing layer 440 at a third joint 436, and the second sound-absorbing layer 440 is attached to the heat-reflective layer 450 at a fourth joint 446.

The five-layer composite insulation article 402 also includes a first outside 404, edges 406, and a second outside 408. The first outside 404 includes the moisture-resistant layer 410, which can provide moisture-resistance for the five-layer composite insulation article 402. The first sound-absorbing layer 420, the fiber-mesh layer 430, and the second sound-absorbing layer 440 are inside the five-layer composite insulation article 402. The second outside 408 includes the heat-reflective layer 450, which can reflect radiant heat away from the five-layer composite insulation article 402. The thicknesses of the first sound-absorbing layer 420 and the second sound-absorbing layer 440 can each be substantially uniform across the five-layer composite insulation article 402, resulting in uniform insulation from noise. The first sound-absorbing layer 420 and the second sound-absorbing layer 440 can be the same thickness or different thicknesses, depending on the particular insulation application, as described in connection with the embodiment of FIG. 2A. In various embodiments of the present disclosure, the five-layer composite insulation article 402 can be substantially rigid. The five-layer composite insulation article 402 can be used to form the five-layer composite insulation article 500 of the embodiment of FIG. 5A.

FIG. 5A illustrates a top view of another embodiment of a five-layer composite insulation article 500 according to the present disclosure. FIG. 5A illustrates a moisture-resistant layer 510, a through-hole 560, and an orientation of the section view of FIG. 5B.

FIG. 5B illustrates a section view of the five-layer composite insulation article 500 according to the present disclosure. The five-layer composite insulation article 500 can be formed from the five-layer composite insulation article 402 of the embodiment of FIG. 4B. The five-layer composite insulation article 500 includes a moisture-resistant layer 510, which can be the moisture-resistant layer 410 of the embodiment of FIG. 4B, a first sound-absorbing layer 520, which can be the first sound-absorbing layer 420 of the embodiment of FIG. 4B, a fiber-mesh layer 530, which can the fiber-mesh layer 430 of the embodiment of FIG. 4B, a second sound-absorbing layer 540, which can be the second sound-absorbing layer 440 of the embodiment of FIG. 4B, and a heat-reflective layer 550, which can be the heat-reflective layer 450 of the embodiment of FIG. 4B. The first sound-absorbing layer 520 includes edges 521, as well as edges 525 around the through-hole 560. The second sound-absorbing layer 540 includes edges 541, as well as edges 545 around the through-hole 560.

The moisture-resistant layer 510 is attached to the first sound-absorbing layer 520 and the second sound-absorbing layer 540. The moisture-resistant layer 510 can be attached to these sound-absorbing layers in various ways, as described in connection with the embodiment of FIG. 2A. The moisture-resistant layer 310 can cover substantially all of a first surface of the first sound-absorbing layer 520, substantially all of the edges 521 and the edges 525 of the first sound-absorbing layer 520, as well as substantially all of the edges 541 and the edges 545 of the second sound-absorbing layer 540. As a result, the moisture-resistant layer 510 can provide moisture-resistance for the first surface, the edges 521 and the edges 525 of the first sound-absorbing layer 520, as well as the edges 541 and the edges 545 of the second sound-absorbing layer 540. The moisture-resistant layer 510 may or may not cover edges and/or edges of the layer of fiber-mesh material 530.

The heat-reflective layer 550 can cover substantially all of a second surface of the sound-absorbing layer 540. The heat-reflective layer 550 can reflect radiant heat away from the second sound-absorbing layer 540. The moisture-resistant layer 510 and the heat-reflective layer 550 can substantially encapsulate the first sound-absorbing layer 520 and the second sound-absorbing layer 540. In an embodiment in which the heat-reflective layer 550 is also moisture-resistant, the moisture-resistant layer 510 and the heat-reflective layer 550 can provide moisture resistance to substantially all sides of the first sound-absorbing layer 520 and the second sound-absorbing layer 540.

The five-layer composite insulation article 500 can be formed from the five-layer composite insulation article 402 of the embodiment of FIG. 4B, in various ways, as described in connection with FIG. 2B.

In an alternate embodiment of the present disclosure, the first sound absorbing layer 540 and/or the second sound-absorbing layer can be mechanically retained by their encapsulation between the moisture-resistant layer 510 and the heat-reflective layer 550, without attaching the first sound absorbing layer 520 to the moisture-resistant layer 510 and/or the fiber-mesh layer 530, as well as without attaching the second sound absorbing material 540 to the fiber-mesh layer 530 and/or to the heat-reflective layer 550.

FIG. 5C illustrates a bottom view of the five-layer composite insulation article 500 according to the present disclosure, including the moisture-resistant layer 510, the heat-reflective layer 550 and the through-hole 560.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that embodiments of the present disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A composite insulation article comprising:
a moisture-resistant layer attached to a first surface of a sound-absorbing layer; and
a heat-reflective layer attached to a second surface of the sound-absorbing layer.

2. The article of claim 1, wherein:
the moisture-resistant layer forms a first outside of the article; and
the heat-reflective layer forms a second outside of the article.

3. The article of claim 1, wherein the article is substantially rigid.

4. The article of claim 1, wherein the sound-absorbing layer includes PET.

5. The article of claim 1, wherein the moisture-resistant layer includes a cross-linked polymer.

6. The article of claim 1, wherein the moisture-resistant layer includes a monolithic elastomeric material.

7. The article of claim 1, wherein the moisture-resistant layer covers substantially all of the first surface of the sound-absorbing layer.

8. The article of claim 7, wherein the moisture-resistant layer covers substantially all of an edge of the sound-absorbing layer.

9. A composite insulation article comprising:
a moisture-resistant layer attached to and covering substantially all of a surface of a first sound-absorbing layer;
the first sound-absorbing layer attached to a rigid fiber-mesh layer;
the fiber-mesh layer attached to a second sound-absorbing layer; and
a heat-reflective layer attached to and covering substantially all of a surface of the second sound-absorbing layer.

10. The article of claim 9, wherein:
the moisture-resistant layer forms a first outside of the article; and
the heat-reflective layer forms a second outside of the article.

11. The article of claim 9, wherein:
the first sound-absorbing layer includes PET; and
the second sound-absorbing layer includes PET.

12. The article of claim 9, wherein the moisture-resistant layer includes a cross-linked polymer.

13. The article of claim 9, wherein the moisture-resistant layer includes a monolithic elastomeric material.

14. A method of manufacturing a composite insulation article, comprising:
attaching a cross-linked polymer layer to a PET layer to form a first outside of the article; and
attaching an aluminum layer to the PET layer to form a second outside of the article.

15. The method of claim 14, wherein the method includes fusing the PET layer to the aluminum layer.

16. The method of claim 14, wherein the method includes adhering the aluminum layer to the PET layer with an adhesive.

17. The method of claim 14, wherein the method includes spraying the cross-linked polymer material onto the PET layer.

18. A vehicle, comprising:
an engine compartment, including an engine;
an exhaust system connected to the engine;
a passenger compartment proximate to the engine compartment and the exhaust system; and
a vehicle insulation article proximate to the passenger compartment, including:
a cross-linked polymer layer attached to a first surface of a PET layer, wherein the cross-linked polymer layer forms a first outside of the vehicle insulation article; and
an aluminum layer attached to a second surface of the PET layer, wherein the aluminum layer forms a second outside of the vehicle insulation article.

19. The vehicle of claim 18, wherein the vehicle insulation article is positioned between the engine compartment and the passenger compartment, with the second outside of the vehicle insulation article facing the engine compartment.

20. The vehicle of claim 18, wherein the vehicle insulation article is positioned between the exhaust system and the passenger compartment, with the second outside of the vehicle insulation article facing the exhaust system.
